(19) United States
(12) Patent Application Publication
(10) Pub. No.: US 2026/0010121 A1
(43) Pub. Date: Jan. 8, 2026

(54) TIMER WITH A SOUND GENERATOR

(71) Applicant: Philipp EIBACH, Fürstenberg/Havel (DE)

(72) Inventor: Philipp EIBACH, Fürstenberg/Havel (DE)

(21) Appl. No.: 19/256,408

(22) Filed: Jul. 1, 2025

(30) Foreign Application Priority Data
Jul. 2, 2024 (DE) 202024103624.7

(51) Int. Cl. G04F 1/00; G10K 1/076

(52) U.S. Cl. CPC G04F 1/005; G10K 1/076

(57) ABSTRACT

A timer including a sound generator, at least one sound-activating element, a drive, and a disk moved by the drive, wherein the moved disk includes at least one detent surface for temporarily holding the sound-activating element in position, and the timer includes at least one deflection element, relative to which the disk moves, such that the deflection element exerts a force on the sound-activating element at a specific time point, which sets the sound-activating element in motion toward the sound generator and ultimately causes the sound generator to emit a sound.

### FIELD OF THE INVENTION

The invention relates to a timer with a sound generator.

### TECHNICAL BACKGROUND

There are numerous fields in which time measurement, particularly interval time measurement, cannot be effectively performed using conventional time measuring tools such as clocks, stopwatches, alarms, egg timers or smartphone functions. In different areas, much more the use of ticking sounds from time measuring devices, disturbing alarms, distraction from technical devices, or radiation from electronic equipment is deliberately avoided. This applies, for example, to meditation, workshops, sports (e.g., yoga, breathing exercises, interval training), therapy (e.g., occupational therapy, teaching the concept of time to children), mediation, or measuring the brewing time of tea or similar.

Accordingly, there is widespread demand for interval time measuring devices that cause minimal distracting interference and/or offer a pleasant tactile sensation and/or a gentle alarm output.

### OBJECT OF THE INVENTION

The object of the invention is therefore to provide a simple way to perform interval time measurement in a minimally distracting manner.

### SUMMARY OF THE INVENTION

The underlying problem is solved according to the invention.

Here a timer with a sound generator is proposed, which comprises at least one sound-activating element, a drive, and a disk moved by the drive. The drive may be an electromechanical or fully electronic clockwork, a stepper motor, or similar. Preferably, the drive is a quartz clockwork. In general, it is preferred that the drive does not produce ticking or other disturbing noises, as is the case with most mechanical wind-up clockworks. The moved disk is preferably a rotating circular disk but may also be designed differently, for example as a linearly moving rectangle or the like.

The timer according to the invention is characterized in that the moved disk has at least one detent surface for temporarily “holding in position”-ideally against gravity—the at least one sound-activating element. This sound-activating element is preferably a ball. To prevent attempts to circumvent this intellectual property right, it should be noted that the sound-activating element could also be implemented in other ways, for example as a preloaded striker that is tensioned like a mousetrap by a spring and, upon release, strikes a sound generator. However, the ball solution, with its harmonious effect and intuitive operability, is clearly preferred.

Furthermore, the timer comprises at least one deflection element, relative to which the disk moves. This movement occurs in such a way that the deflection element exerts a force-whether mechanical, magnetic, or similar-on the at least one sound-activating element at a specific time point. As a result, the sound-activating element is set into motion toward the sound generator and ultimately causes it to emit sound.

Depending on the speed of the disk's movement, the sound-activating element is thus deflected from its position in the detent surface by the deflection element after a defined distance and moved toward the sound generator, preferably by gravity, so that a sound is emitted at this defined time point, indicating the end of a specific interval after the sound-activating element interacts with the sound generator, preferably by directly striking it.

In this way, a clear signal can be provided to indicate the end of an interval in a simple, mechanical, and non-disruptive manner.

This results in a visual representation and a haptic interaction with the concept of time, especially with intervals.

The mechanical generation of sound leads to a more pleasant alarm sound. In addition, simple forward and backward rotation or adjustment of the time is possible. The timer is particularly suitable for blind or visually impaired individuals, as it can be operated purely through tactile means.

### Optional Further Development Options

A preferred embodiment of the timer consists in that the moved disk is a profile disk, which is shaped in such a way that it comprises at least one raised detent surface for metastable holding a sound-activating element. This previously mentioned detent surface thus holds the sound-activating element in its upper position in a simple manner while it “waits” for deflection by the deflection element. The metastable state generally describes a system that remains stable under small disturbances but becomes unstable under larger disturbances and preferably transitions into another (stable or again metastable) state.

Furthermore, the profile disk comprises at least one rolling or sliding surface over which the sound-activating element, after being subjected to the force exerted by the deflection element, can move on its own into a lower position in which it interacts with the sound generator. The deflection by the deflection element is thus a sufficient force to set the sound-activating element into motion and to overcome the metastable state in the upper position; a smaller vibration or other disturbances should preferably not be able to trigger this movement. The mentioned “interaction with the sound generator” preferably describes a mechanical striking of a bell, sound bowl, or similar, or the activation of an electrical or electronic sound generator.

Furthermore, it is particularly preferred if the at least one sound-activating element is a rolling body, preferably a ball, preferably made of metal, ceramic, stone, or wood, with the rolling body ideally being driven solely by gravity on its path from the metastable position toward the sound generator. In this way, a smoothly rolling, sound-activating element can be provided simply and cost-effectively. Moreover, the weight and material of the rolling body can easily influence the volume and the sound produced when it contacts the sound generator.

In some cases, it is advantageous if different rolling bodies are used with equal spacing, for example one or more lighter rolling bodies, such as those made of plastic, which produce only a softer intermediate tone upon release, e.g., every quarter hour, and at least one heavier rolling body, which produces a louder tone, e.g., every hour or at the end of the set interval.

It is also particularly preferred if the moved disk, in the form of a profile disk, comprises a track formed in guiding manner-preferably in the form of a groove-which influences the direction of movement of the sound-activating element after it has been pushed from its metastable position by the deflection element, where this influence preferably extends along the entire or substantially entire path between the edge of the metastable position and the sound generator. This allows the path of the sound-activating element from its upper position to be simply directed and guided to achieve a desired rolling and sounding behavior.

The grooves are designed, at least along their track, in such a way that the balls produce no or only minimal audible noise while rolling. For this purpose, it is particularly preferred that the material of the track has a correspondingly high internal damping (typically with a loss factor of 0.2 or higher) and/or a low modulus of elasticity (typically up to 1500 MPa). It is therefore preferred that the groove material is composed at least in part of felt, cork, velvet, velour or plastic, such as silicone, a polyurethane with a Shore A hardness of 50 to 90, silicone rubber, EPDM rubber, or EVA foam.

Furthermore, it is particularly preferred that the groove is U-shaped or, better yet, V-shaped, and preferably becomes narrower and/or deeper in the direction of the sound generator. This prevents, in a simple manner, the sound-activating element from derailing into an adjacent groove due to the rebound upon impacting the sound generator, thereby avoiding unintended sound effects or obstructions that could prevent the next sound-activating element in the adjacent groove from triggering an uninterrupted sound event.

Another preferred embodiment consists in the slope of the groove, the sound-activating element, and the sound generator being coordinated in such a way that the sound-activating element, upon impacting the sound generator, experiences a rebound and/or a gravitational force component pulling it downhill, which moves and preferably keeps it away from the sound generator.

This is because a mechanical bell or an equivalent sound generator can only resonate freely if the clapper or sound-generating element lifts off again immediately after striking the bell; otherwise, damping occurs, and the sound does not sound as intended. This can be ensured in such a way in a simple manner.

Furthermore, it is particularly preferred that the groove includes a second detent surface, which is shaped and arranged to catch and hold the sound-activating element after its first interaction with the sound generator. Compared to the upper, first detent surface, this second detent surface is preferably positioned lower and ensures, in a simple way, that the sound-activating element does not roll down the groove again after rebounding from the contact with the sound generator and thereby unintentionally interact with the sound generator a second time. Preferably, only a single defined impact is to be executed. The state at the second detent surface is, analogous to the first, a metastable state, although in this case the goal is not to deflect the sound-activating element again with a deflection element, but rather for it to remain there until manually returned to the initial position at the first detent surface. It is preferred that the second detent surface is positioned far enough from the sound generator to allow another ball on an adjacent groove to roll down toward the sound generator without obstruction.

It is also particularly preferred if the moved disk is a circular disk, which preferably features several grooves, ideally arranged in a star-shaped or spiral configuration.

In this way, the required grooves can be easily provided on the disk, allowing the disk to be manufactured simply and cost-effectively.

Furthermore, it is particularly preferred that the deflection element is formed by at least one cam, against which a sound-activating element-when it is in a metastable position, preferably on the first detent surface-comes into contact during the movement of the disk and is then pushed out of this metastable position. This ensures a defined deflection and a defined start of the movement of the sound-activating element in a simple manner.

Additional effects, advantages, and configuration options result from the figure-supported description of the exemplary embodiment.

### BRIEF DESCRIPTION OF DRAWINGS

FIG. 1 shows a preferred embodiment of the timer according to the invention in a three-dimensional view.

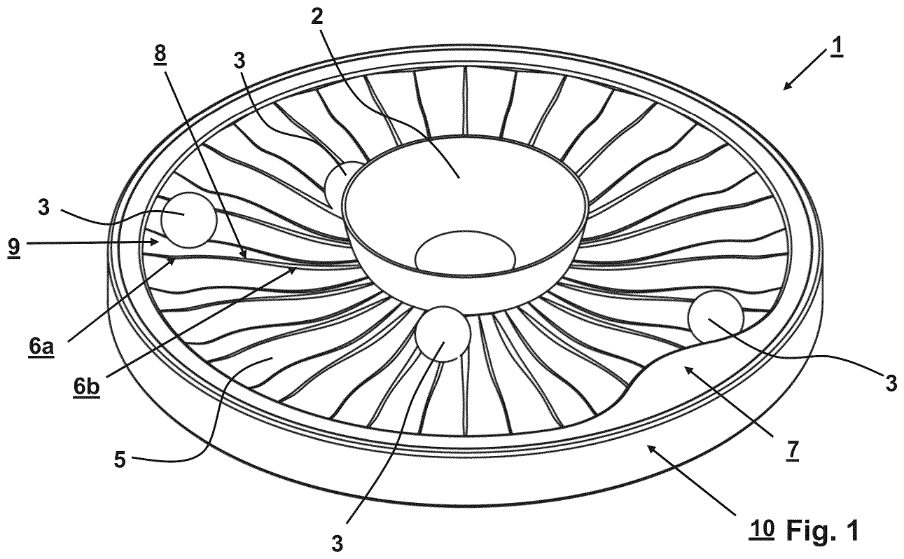

FIG. 2 shows the preferred embodiment of the timer according to the invention in a top view.

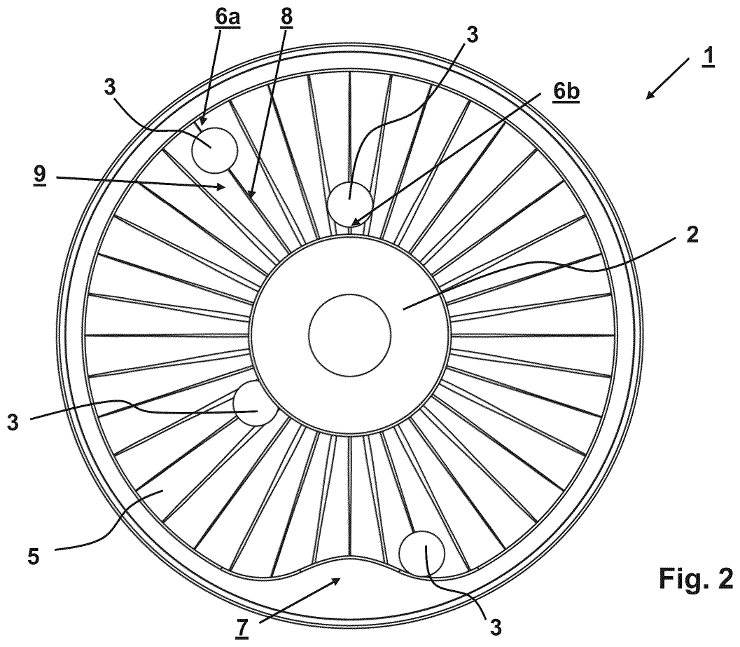

FIG. 3 shows the preferred embodiment of the timer according to the invention in a bottom view.

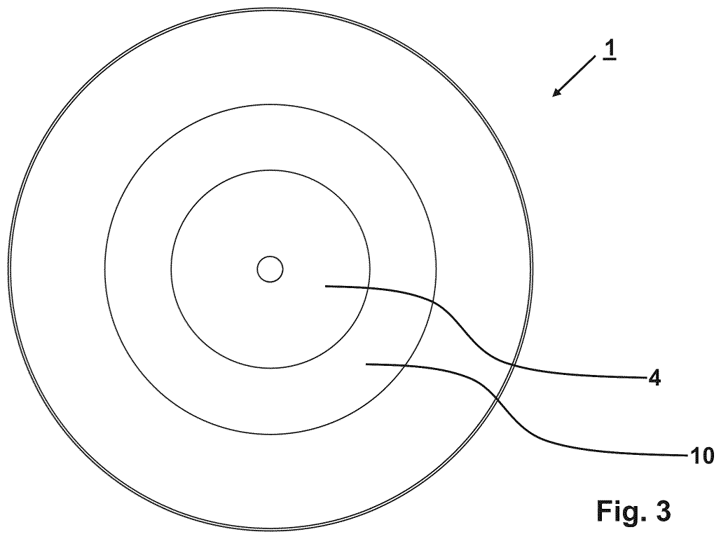

FIG. 4 shows the preferred embodiment of the timer according to the invention in a side view.

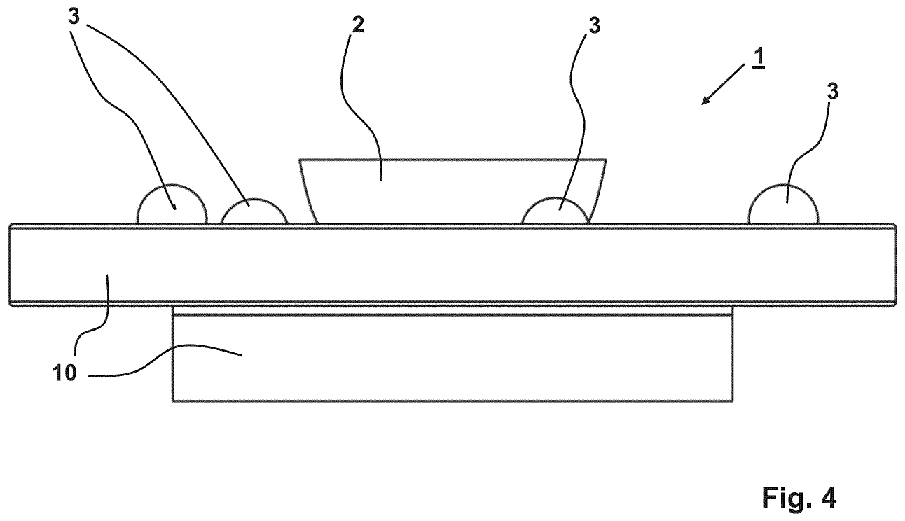

### DETAILED DESCRIPTION OF THE INVENTION

The timer 1 according to the invention preferably comprises a point-symmetrical moved disk 5, at the center of which a sound generator 2 is positioned. This sound generator 2 is preferably a bell or a sound bowl. The disk 5 is preferably a circular profile disk. The disk 5 further preferably features several point-symmetrical grooves 9, which extend radially toward the center. The grooves 9 generally have a downward slope from the radial outer edge toward the radial inner edge, with the first detent surface 6a and the second detent surface 6b can be seen as exceptions. Preferably, a first detent surface 6a is provided at the radial outer end of each groove 9, serving as the rest position and starting position for the respective sound-activating element 3. The second detent surface 6b is preferably located around the lowest point of the groove 9, ideally at approximately two-thirds of the groove's length toward the center of the disk 5.

When a sound-activating element 3 is guided from its resting position on the first detent surface 6a into the groove, it rolls downward along the rolling surface 8, touches the sound generator 2, receives an impulse away from the sound generator 2, and then rolls into the detent surface 6b, which lies lower than the end of the groove 9 where it contacts the sound generator 2.

The sound-activating element 3 is preferably a ball. Across the entire timer 1, various balls can preferably be arranged in the grooves 9 to measure different intervals—for instance, for different individuals—or to generate intermediate signals (e.g., after every 5 minutes) and an end signal (e.g., after 15 minutes).

The moved disk 5 is driven by a drive 4 and is preferably mounted on the drive 4. The drive 4 is, for example, mounted on the minute axis of a clockwork, which functions as the drive 4. In this case, the disk 5 rotates once every hour by 360°. The disk 5 and the drive 4 are preferably mounted inside a housing 10. At the upper edge of the housing 10, which at least partially encloses the disk 5, a deflection element 7 is located, in the form of a cam that soundly protrudes above the disk 5. The shape of the deflection element 5 is dimensioned in such a way that, during the rotation of the disk 5, it pushes a sound-activating element 3 out of its resting position on the first detent surface 6a, causing it to be guided onto the rolling surface 8 of the groove 9 and to roll downward along it-preferably in such a way that the sound-activating element 3 gains enough energy through gravity to overcome the second detent surface 6b.

The disk 5 can preferably also be manually rotated freely. This allows the rotation and thus the distance of the sound-activating elements 3 from the deflection element 7 to be determined manually, enabling manual setting of the endpoint of the timer.

### General Information

The timer is preferably available in various sizes and shapes. In addition to the standard version for personal use (approximately 20 cm in diameter), larger versions are preferably available for applications such as yoga or meditation centers. These may have a diameter of 1 m or more and a correspondingly greater height.

The housing with the deflection element and the sound-activating elements is also preferably available in different variants, optimized for the specific use case. For example, markings may be present on the housing to simplify the setting of specific times. For workshops, sound-activating elements with different colors may preferably be provided for individual participants.

Disks with different ball tracks are also preferably available. Likewise, the sound generator may vary in size, shape, and type of sound.

Variants are also provided in which the sound-activating elements move along a ring around a single central ball track, into which they are guided by the deflection element.

It is also conceivable to offer other beats of the clockwork or drive, such that the disk rotates, for example, once every 12 hours instead of once per hour.

1. A timer comprising:
a sound generator;
at least one sound-activating element;
a drive; and
a disk moved by the drive, wherein the moved disk comprises at least one detent surface for temporarily holding the at least one sound-activating element in position, wherein the timer comprises at least one deflection element, relative to which the disk moves, such that the at least one deflection element exerts a force on the at least one sound-activating element at a specific time point, which sets the at least one sound-activating element in motion toward the sound generator and ultimately causes the sound generator to emit a sound.

2. The timer according to claim 1, wherein the moved disk is a profile disk shaped in such a way that the moved disk comprises at least one elevated detent surface for metastable holding a sound-activating element and a rolling surface or sliding surface, along which the at least one sound-activating element can move on its own to a lower position as a result of the force exerted on the at least one sound-activating element by the at least one deflection element, and as a result the at least one sound-activating element interacts with the sound generator.

3. The timer according to claim 1, wherein the at least one sound-activating element is a rolling body, and the rolling body is driven solely by gravity on its path from a metastable position toward the sound generator.

4. The timer according to claim 3, wherein the at least one sound-activating element is a ball made of metal or stone.

5. The timer according to claim 2, wherein the moved disk, in the form of a profile disk, comprises a guiding track which influences a direction of movement of the at least one sound-activating element that has been pushed out of a metastable position by the at least one deflection element, the influence extending substantially along an entire length between an edge of the metastable position and the sound generator.

6. The timer according to claim 5, wherein the guiding track is a groove.

7. The timer according to claim 6, wherein the groove is U-shaped or V-shaped, and becomes narrower and/or deeper in a direction of the sound generator.

8. The timer according to claim 6, wherein a slope of the groove, the at least one sound-activating element, and the sound generator are coordinated such that the at least one sound-activating element, upon impacting the sound generator, experiences a rebound and/or a gravitational force component that moves the at least one sound-activating element away from the sound generator.

9. The timer according to claim 8, wherein the groove comprises a second detent surface, which is shaped and arranged to catch and hold the at least one sound-activating element after a first interaction of the at least one sound-activating element with the sound generator.

10. The timer according to claim 1, wherein the moved disk is a circular disk, which comprises a plurality of grooves arranged on the circular disk.

11. The timer according to claim 10, wherein the plurality of grooves arranged on the circular disk are arranged in a star-shaped or spiral configuration.

12. The timer according to claim 10, wherein the sound generator is positioned at a center or occupies the center of the moved disk, in the form of a circular disk, and is formed by a mechanical bell which is struck by an impact of the at least one sound-activating element, in the form of a rolling body, wherein the mechanical bell forms an upwardly open bowl.

13. The timer according to claim 1, wherein the at least one deflection element is formed by at least one cam, against which the at least one sound-activating element, when the at least one sound-activating element is in a metastable position, comes into contact during a movement of the disk and is then pushed out of the metastable position.

14. The timer according to claim 13, wherein the moved disk is a circular disk and the at least one deflection element, in a form of the at least one cam, extends in a radially inward direction.
